(19) United States
(12) Patent Application Publication
(10) Pub. No.: US 2006/0195452 A1
(43) Pub. Date: Aug. 31, 2006

(54) SYSTEM AND METHOD FOR OPERATING FILES ON A WEB PAGE

(76) Inventor: Tzu-Chiang Peng, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,662

(22) Filed: Dec. 1, 2005

(30) Foreign Application Priority Data
Dec. 3, 2004 (TW) 093137393

(51) Int. Cl. G06F 17/30

(52) U.S. Cl. 707/10

(57) ABSTRACT

A system for operating files on a web page is executed in one or more HTTP clients (14). The system includes: a web page opening module (160) for opening a web page from an HTTP server (15) connected to the clients and displaying a file list on the web page; a determining module (161) for determining whether a mouse cursor is locating in a range of a hyperlink of a file to be operated, and determining whether any key value has been caught; a key value catching module (162) for focusing the mouse cursor on the hyperlink of the file, and catching key values from a keyboard (12); and a conversion module (164) for converting the key values to corresponding instructions, and transmitting the instructions and the file to the server for operating the file according to the instructions. A related method is also provided.

### FIELD OF THE INVENTION

The present invention relates to a system and method for operating files, and more particularly to a system and method for operating files on a web page.

### DESCRIPTION OF RELATED ART

With the fast development of the server and Internet, searching and managing information resources of a significant server via the Internet has become an important and interesting thing for more and more people, and computers have also been used to manage files.

It is well known that information is generally stored in the servers in a variety of file types. Current operating systems organize the server files into a directory tree; all the files relating to a specific application are stored in a directory created by the system or the user. For example, in the Windows operating system, all of the system files are put in a directory named “Windows.” Users can put his files in the directory built for himself such as “My Documents.” In a file server consisting of large quantity of information, all the files are also located in different directories having the tree structure.

In this way, it is time consuming for a user to operate a file of a specific topic. It is worse especially for operating a file from a large file set. In order to operate a file, one typical case is that the user utilizes a web page as an interface to manage the files of servers, and he has to lay a small icon beside each file in the file list of the web page, which is impossible in the operation speed. As FIG. 1, there are eight files named from file1 to file8 on a web page, and there is a small icon (11) beside each file. For example, it is requisite to press the small icon (11) beside the file2 when a user wants to operate the file2.

What is needed, therefore, is a system and method which can operate a file on a web page expediently and fleetly.

### SUMMARY OF INVENTION

A system for operating files on a web page is executed in a client which is linked with a server via a network. The system includes: a web page opening module for opening a web page from the server and displaying a file list on the web page; a determining module for determining whether a mouse cursor is locating in a range of a hyperlink of a file to be operated, and determining whether any key value has been caught; a key value catching module for focusing the mouse cursor on the hyperlink of the file, and catching key values from a keyboard connected to the client; and a conversion module for converting the key values to corresponding instructions, and transmitting the instructions and the file to the server for operating the file according to the instructions.

A computer-based method for operating files on a web page in accordance with a preferred embodiment of the present invention includes the steps of: opening a web page from a server and displaying a file list on the web page; moving a mouse cursor of a client to a file to be operated; determining whether the mouse cursor is locating in a range of a hyperlink of the file; focusing the mouse cursor on the hyperlink of the file, and waiting for catching key values from a keyboard connected to the client, if the mouse cursor is locating in the range of the hyperlink; determining whether any key value has been caught; converting the key values to corresponding instructions if key values have been caught; and transmitting the instructions and the file to the server for operating the file according to the instructions.

Other advantages and novel features of the present invention will become more apparent from the following detailed description of preferred embodiments when taken in conjunction with the accompanying drawings, in which:

### BRIEF DESCRIPTION OF DRAWINGS

FIG. 1 is a schematic diagram of a conventional way for operating files on a web page;

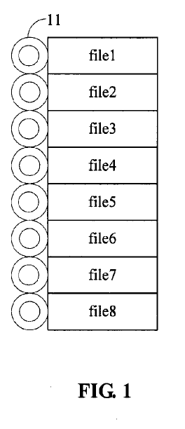

FIG. 2 is a schematic diagram of hardware configuration of a system for operating files on a web page in accordance with a preferred embodiment of the present invention;

FIG. 3 is a schematic diagram of main function modules of the system of FIG. 2;

FIG. 4 is a schematic diagram of an operation interface for operating files on a web page; and

FIG. 5 is a flowchart of a method for operating files on a web page in accordance with a preferred embodiment of the present invention.

### DETAILED DESCRIPTION

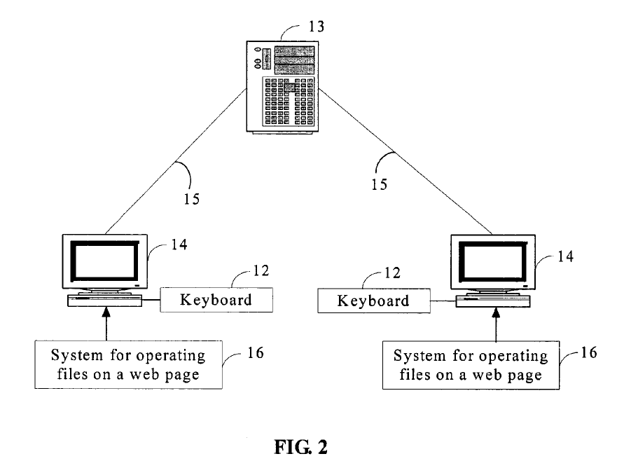

FIG. 2 is a schematic diagram of hardware configuration of a system for operating files on a web page in accordance with a preferred embodiment of the present invention. The system for operating files on a web page 16 (hereinafter, “the system 16′) is executed in a plurality of HTTP (Hypertext Transfer Protocol) clients 14 (only two shown), which are linked with a HTTP server 13 via a network 15. Each HTTP client 14 is connected to a keyboard 12 as a device for users to input operation instructions.

The system 16 provides an operation interface, through which users can manage files on a web page. Specifically, the system 16 is used for determining a moving range of a mouse cursor, booting a key value catching function, determining whether a key value has been caught, converting the key value into a corresponding instruction, and transmitting the instruction and the files to be managed to the HTTP server 13.

The network 15 can be an intranet, the Internet, or any other suitable type of communications link.

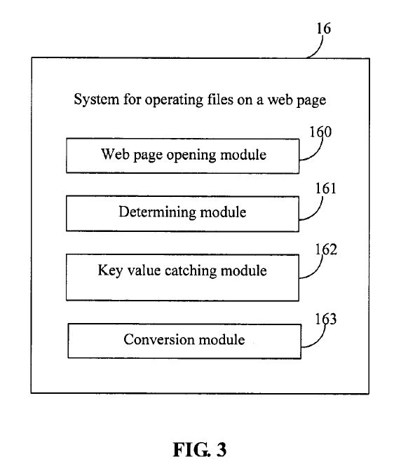

FIG. 3 is a schematic diagram of main function modules of the system 16. The system 16 typically includes a web page opening module 160, a determining module 161, a key value catching module 162, and a conversion module 163.

The web page opening module 160 is used for opening a web page from the HTTP server 13 and displaying a file list on the web page. When a user wants to have a particular operation on a file in the file list, he/she can set a mouse cursor in a range of a hyperlink of the file, which is typically a square formed around the file name above the hyperlink, and then press a corresponding key on the keyboard 12 connected to the HTTP client 13.

The determining module 161 is used for determining whether the mouse cursor is locating in a range of a hyperlink of a file via an on MouseOver event, and determining whether the mouse cursor has left a range of a hyperlink of a file via an on MouseOut event. The determining module 161 is also used for determining whether a key value has been caught via an on KeyDown event of a hyperlink of a file.

Generally, the on MouseOver event happens when the mouse cursor is locating in a range of a hyperlink of a file, and the on MouseOut event happens when the mouse cursor leaves a range of a hyperlink of a file. Because a window.event.keycode (hereinafter, “event.keyCode”) defined in Dynamic Hypertext Marked Language (DHTML) stores key values input from the keyboard 12, the on KeyDown event can be invoked when the mouse cursor focuses on a hyperlink of a file and a key of the keyboard 12 is pressed. Then, a corresponding key value is stored in the event.keycode. Thus, the determining module 161 determines whether a key value has been caught by querying whether the event.keycode has values.

The key value catching module 162 is used for focusing a mouse cursor on a hyperlink of a file compulsively and catching key values from the keyboard 12 via calling functions provided by the operation system or a key value catching function defined by users, and storing the caught key values in the event.keycode.

Once a key of the keyboard 12 is pressed, a key value expressed by American Standard Code for Information Interchange (ASCII) is stored in the event.keyCode by the key value catching module 162. Each ASCII value corresponds to an instruction for executing a certain action. For example, the “delete” key corresponds to the action of deleting files or data in the Windows operating system.

The conversion module 163 is used for converting the key values caught by the key value catching module 162 to corresponding instructions, and transmitting the instructions and the file to be managed to the HTTP server 13. For example, event.shiftKey denotes the “Shift” key, event.ctrlKey denotes the “Ctrl” key, and event.altKey denotes the “Alt” key. A code “if (event.shiftKey && event.rkey==82) do a certain action A” means when the “Shift” key and “R” key are pressed simultaneously, the action A is to be executed. The key values corresponding to the “Shift” key and “R” key are stored in the event.keyCode.

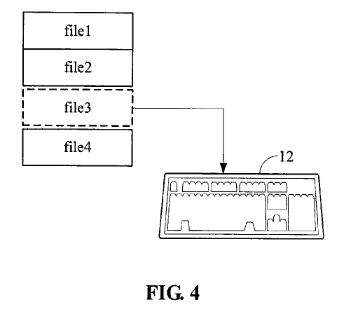

FIG. 4 is a schematic diagram of an operation interface for operating files on a web page. For the operation interface, the mouse cursor is locating in the range of the hyperlink of file3. The range of the hyperlink is denoted with a virtual square frame. An HTTP client 14 waits for catching key values from a keyboard 12 to operate the file3 accordingly.

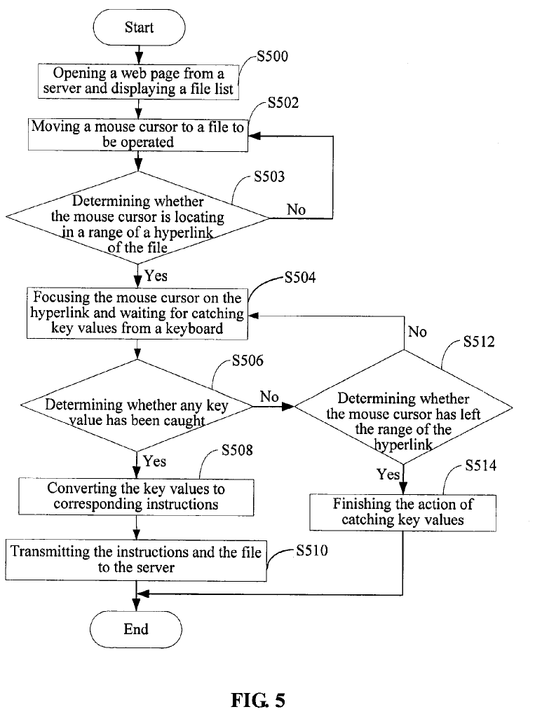

FIG. 5 is a flowchart of a method for operating files on a web page in accordance with a preferred embodiment of the present invention. In step S500, a HTTP client 14 activates the web page opening module 160. The web page opening module 160 opens a web page from the HTTP server 13 and displays a file list on the web page. In step S502, a user moves a mouse cursor of the HTTP client 14 to a file in the file list if the user wants to have a particular operation on the file. In step S503, the HTTP client 14 activates the determining module 161. The determining module 161 determines whether the mouse cursor is locating in a range of a hyperlink of the file, namely, the determining module 161 determines whether an on MouseOver event of the hyperlink happens. If the mouse cursor is not locating in the range of the hyperlink, the procedure goes back to step S502 described above. If the mouse cursor is locating in the range of the hyperlink, in step S504, the HTTP client 14 activates the key value catching module 162. The key value catching module 162 focuses the mouse cursor on the hyperlink compulsively, and waits for catching key values from a keyboard 12 connected to the HTTP client 14. At this time, an on KeyDown event happens when the mouse cursor focuses on the hyperlink. In step S506, the determining module 161 determines whether any key value has been caught, namely, the determining module 161 determines whether there is any key value in the event.keycode. If there are key values in the event.keycode, in step S508, the HTTP client 14 activates the conversion module 163. The conversion module 163 converts the key values to corresponding instructions, which may be deleting instructions, editing instructions, and/or downloading instructions. In step S510, the conversion module 163 transmits the instructions and the file to be managed to the HTTP server 13 for doing certain actions corresponding to the instructions. Otherwise, if there is no key value in the event.keycode, in step S512, the determining module 161 determines whether the mouse cursor has left the range of the hyperlink via the on MouseOut event. If the mouse cursor has left the range of the hyperlink, in step S514, the HTTP client 14 finishes the action of the key value catching module 162, and the procedure ends. Otherwise, if the mouse cursor is still locating in the range of the hyperlink, the procedure goes back to step S504 described above.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for operating files on a web page, the system being executed in a client which is linked with a server via a network, the system comprising:
a web page opening module for opening a web page from the server and displaying a file list on the web page;
a determining module for determining whether a mouse cursor is locating in a range of a hyperlink of a file to be operated, and determining whether any key value has been caught;
a key value catching module for focusing the mouse cursor on the hyperlink of the file, and catching key values from a keyboard connected to the client; and
a conversion module for converting the key values to corresponding instructions, and transmitting the instructions and the file to the server for operating the file according to the instructions.

2. The system as claimed in claim 1, wherein the determining module is further used for determining whether the mouse cursor has left the range of the hyperlink of the file.

3. A computer-based method for operating files on a web page, the method comprising the steps of:
opening a web page from a server and displaying a file list on the web page;
moving a mouse cursor of a client to a file to be operated;
determining whether the mouse cursor is locating in a range of a hyperlink of the file;
focusing the mouse cursor on the hyperlink of the file, and waiting for catching key values from a keyboard connected to the client, if the mouse cursor is locating in the range of the hyperlink;
determining whether any key value has been caught;
converting the key values to corresponding instructions if key values have been caught; and
transmitting the instructions and the file to the server for operating the file according to the instructions.

4. The method as claimed in claim 3, further comprising the steps of:
determining whether the mouse curse has left the range of the hyperlink if no key value has been caught;
returning to the focusing step if the mouse cursor is still locating in the range of the hyperlink; and
ending the procedure if the mouse cursor has left the range of the hyperlink.
